(19) United States
(12) Patent Application Publication
(10) Pub. No.: US 2023/0408688 A1
(43) Pub. Date: Dec. 21, 2023

(54) SYSTEM AND METHOD FOR DRIVE CONTROL OF FRONT ULTRA-SONIC SENSORS

(71) Applicant: HYUNDAI MOBIS CO., LTD., Seoul (KR)

(72) Inventor: Jae Young LEE, Icheon-si (KR)

(73) Assignee: HYUNDAI MOBIS CO., LTD., Seoul (KR)

(21) Appl. No.: 18/146,402

(22) Filed: Dec. 26, 2022

(30) Foreign Application Priority Data
May 17, 2022 (KR) 10-2022-0060069

(51) Int. Cl. G01S 15/931; G01S 15/08; G01S 15/86; G06V 20/58; G06V 10/26; G06V 10/75

(52) U.S. Cl. CPC G01S 15/931; G01S 15/08; G01S 15/86; G01S 2015/937; G06V 10/26; G06V 10/751; G06V 20/58

(57) ABSTRACT

Provided are a system and a method for drive control of front ultra-sonic sensors, which may minimize interference with another vehicle, caused by an ultra-sonic wave signal in a complex driving environment by detecting presence or absence of an obstacle in front and controlling a drive state of the front ultra-sonic sensor mounted on the front bumper of a vehicle.

### CROSS-REFERENCE TO RELATED APPLICATIONS

This application claims priority under 35 U.S.C. § 119 to Korean Patent Application No. 10-2022-0060069, filed on May 17, 2022, in the Korean Intellectual Property Office, the disclosure of which is incorporated herein by reference in its entirety.

### TECHNICAL FIELD

The following disclosure relates to a system and a method for drive control of front ultra-sonic sensors, and more particularly, to a system and a method for drive control of front ultra-sonic sensors, which may control a drive state of the front ultra-sonic sensor mounted on the front of a vehicle and detect the presence or absence of an obstacle positioned in front of the vehicle to reduce a probability of malfunction/misdetection which may occur due to interference from a nearby vehicle.

### BACKGROUND

In recent years, various sensors (e.g., camera sensor and radar sensor) have been mounted in a vehicle to provide various advanced functions to help a driver's safe and comfortable driving.

For example, the vehicle may be mounted with a ‘front camera sensor’ and a ‘front radar sensor’. The front camera sensor may be usually installed on the top of a windshield of the vehicle to identify a nearby object and a lane in its driving direction, and the front radar sensor may be positioned on the radiator grill or a front bumper (positioned below the radiator grill) to detect an object in front thereof. The sensors may use these functions to provide a lane keeping assist (LKA) function, a lane following assist (LFA) function, a forward collision-avoidance assist (FCA) function, a smart cruise control (SCC) function, a highway driving assist (HAD) function, or the like.

The vehicle may also be mounted with a ‘front ultra-sonic sensor’. The front ultra-sonic sensor may be mounted on a front bumper of the vehicle, and detect a distance to an object within a predetermined distance (or in a range that the ultra-sonic sensor is able to detect) when the vehicle is moved forward. The sensor may use this function to provide a front parking distance warning (PDW) function. The PDW function is a function to notify the driver that there is an obstacle through a route notification, in case that the object is detected within the predetermined distance when the vehicle is moved forward, which is added to assist the vehicle to be safely moved when parked in or exiting from a narrow space such as an alley.

In addition, the vehicle may be mounted with a ‘rear camera sensor’ and a ‘rear ultra-sonic sensor’. The rear camera sensor may be mounted on the rear of the vehicle and transmit a rear situation to the driver through a navigation screen when the vehicle is moved backward, and the rear ultra-sonic sensor may be mounted on a rear bumper of the vehicle and detect a distance to an object within a predetermined distance (or in a range that the ultra-sonic sensor is able to detect) when the vehicle is moved backward. The sensor may use this function to provide a reverse parking collision-avoidance assist (RCA) function, a rear parking distance warning (PDW) function and a remote smart parking assist (RSPA) function, and use the above function of the front camera sensor together to provide a surround view monitor (SVM) function.

The vehicle may also be mounted with a ‘rear-lateral radar sensor’. Unlike the rear ultra-sonic sensor, the rear-lateral radar sensor may be mounted in the rear bumper and detect an object in the rear of the vehicle. The sensor may use this function to provide a blind-spot collision-avoidance assist (BCA) function and a safe exit assist (SEA) function.

The vehicle is designed in such a manner that the front ultra-sonic sensor and the rear ultra-sonic sensor use ultra-sonic sensors of the same specification different from each other only in their mounting positions.

When these ultra-sonic sensors are constantly driven, ultra-sonic sensors installed and operated on different vehicles may act as mutual noise sources/interference sources, thereby lowering an overall performance of a parking assistance system.

As an example of a situation where the interference occurs, as shown in FIG. 1, four front ultra-sonic sensors may be generally mounted on the front bumper of a vehicle. Here, a front-center ultra-sonic sensor may transmit a front ultra-sonic wave, and a front-lateral ultra-sonic sensor may transmit a front-lateral ultra-sonic wave. Therefore, when the front ultra-sonic sensor is constantly driven, the front ultra-sonic wave may be blocked from transferring its energy by reflection of a vehicle in a case that there is the vehicle in front (i.e., unless the vehicle in front is moved backward and activates its rear ultra-sonic sensor). However, the front ultra-sonic sensor of a vehicle entering from another direction may interfere with the front-lateral ultra-sonic wave.

In addition, as shown in FIG. 2, even when there is a vehicle only in front, the front ultra-sonic wave may be transmitted to another vehicle rather than being blocked from transferring its energy by reflection of the vehicle in front, to cause the interference due to diffused reflection between the ground and the underside of the vehicle in front.

As described above, the ultra-sonic sensor of a nearby vehicle may have an increased probability of performing misdetection when there is the nearby vehicle of which the ultra-sonic sensor is constantly driven. In order to solve this problem, proposed is a method of activating the ultra-sonic sensor only when necessary by fundamentally classifying its operation condition.

The rear ultra-sonic sensor may be set to be activated only when a vehicle gear is in an ‘R’ stage which is an explicit reverse situation, thereby lowering the probability of misdetection/false alarm.

However, in case of the front ultra-sonic sensor, both a parking situation where the front parking distance warning (PDW) function needs to be provided and a general driving situation are in the same condition in which the gear is in a ‘D’ stage. It is thus impossible to set the front ultra-sonic sensor to be activated only in the parking situation by determining the situation. That is, it is almost impossible to activate the front ultra-sonic sensor by determining this situation as the parking situation even when the vehicle enters a parking lot and approaches an obstacle in front.

Accordingly, until now, the front ultra-sonic sensor is set to be activated only by the driver's operation (of a PDW switch) as a drive condition of the sensor.

When the vehicle enters a parking lot or narrow alley having a narrow passage, it may not only be inconvenient for the driver to operate the PDW switch while being careful about scratching the vehicle, but also cause another problem in that a risk of an accident is increased as the driver neglects to watch the front while operating the PDW switch because the PDW switch is usually positioned near a gear knob.

In this regard, Korean Patent Laid-Open Publication No. 10-2021-0143371 (entitled, “VEHICLE FRONT OBJECT DETECTION SYSTEM AND METHOD”), discloses technology for further improving safety of a vehicle by analyzing information on a front object detected by an ultra-sonic sensor when a driving condition of the vehicle satisfies a predetermined standard condition, and controlling the vehicle by using the analyzed information.

### SUMMARY

Embodiments of the present disclosure are directed to providing a system and a method for drive control of front ultra-sonic sensors, which may control a transmission waveform output from a front ultra-sonic sensor to minimize an ultra-sonic wave transmitted to another vehicle while constantly driving the front ultra-sonic sensor, thereby minimizing interference from another vehicle.

In one general aspect, a system for drive control of front ultra-sonic sensors mounted on the front of a vehicle and detecting an obstacle positioned in front of the vehicle includes: a sensor position analysis unit analyzing a mounting position of each of a plurality of front ultra-sonic sensors mounted on the vehicle to classify a first ultra-sonic sensor mounted on the side and a second ultra-sonic sensor mounted on the center; an obstacle detection unit detecting the obstacle positioned in front of the vehicle within a predetermined distance by using input data related to the front of the vehicle to analyze distance information between the vehicle and the detected obstacle; and an output control unit controlling a waveform output from each ultra-sonic sensor classified by the sensor position analysis unit by using the distance information analyzed by the obstacle detection unit.

The sensor position analysis unit may analyze the mounting position of each of the plurality of front ultra-sonic sensors by using identification (ID) information assigned in advance for each front ultra-sonic sensor or ID information assigned in advance to a connection cable of each front ultra-sonic sensor.

The obstacle detection unit may receive at least one of data from a linked unit as data related to the front of the vehicle, the data including vehicle front image data, generated by matching images input from a plurality of camera sensors mounted on the vehicle into one view, and sensing data detected by the front ultra-sonic sensor.

The obstacle detection unit may include: a region segmentation unit segmenting a region corresponding to an obstacle region from the vehicle front image data; and a first distance analysis unit analyzing a pixel position corresponding to the obstacle region segmented by the region segmentation unit to analyze the distance information between the vehicle and the obstacle.

The obstacle detection unit may further include a second distance analysis unit analyzing the sensing data to analyze the distance information between the vehicle and the detected obstacle.

The output control unit may include a side output control unit controlling the waveform output from the ultra-sonic sensor to have a predetermined value when the sensor is the first ultra-sonic sensor as a result of the classification of the sensor position analysis unit.

The output control unit may include a center output control unit controlling the waveform output from the corresponding ultra-sonic sensor by using the distance information analyzed by the obstacle detection unit when the sensor is the second ultra-sonic sensor as a result of the classification of the sensor position analysis unit.

The center output control unit may include: a first determination unit determining whether the distance information falls within a first predetermined distance; and a first control unit controlling a waveform output from the corresponding ultra-sonic sensor to have a predetermined value when the distance information does not fall within the first predetermined distance, based on a result of the determination of the first determination unit.

The center output control unit may include: a second determination unit determining whether the distance information falls in a range of a second predetermined distance when the distance information falls within the first predetermined distance, based on the result of the determination of the first determination unit; and a second control unit controlling the waveform output from the corresponding ultra-sonic sensor to correspond to the distance information when the distance information falls in the range of the second predetermined distance, based on a result of the determination of the second determination unit.

In another general aspect, a method for drive control of front ultra-sonic sensors, in which the method uses a system for drive control of front ultra-sonic sensors, each operation of the system being performed by a calculation processing means, includes: a sensor position analysis operation (S100) of analyzing a mounting position of each of a plurality of front ultra-sonic sensors mounted on the front of a vehicle to classify a first ultra-sonic sensor mounted on the side and a second ultra-sonic sensor mounted on the center; a side output control operation (S200) of controlling a waveform output from the corresponding ultra-sonic sensor to have a predetermined value when the sensor is the first ultra-sonic sensor as a result of the classification in the sensor position analysis operation (S100); and a center output control operation (S300) of controlling a waveform output from the corresponding ultra-sonic sensor by analyzing distance information between the vehicle and an obstacle positioned in front of the vehicle within a predetermined distance when the sensor is the second ultra-sonic sensor as the result of the classification in the sensor position analysis operation (S100).

In the sensor position analysis operation (S100), the mounting position of each of the plurality of front ultra-sonic sensors may be analyzed by using identification (ID) information assigned in advance for each front ultra-sonic sensor or ID information assigned in advance to a connection cable of each front ultra-sonic sensor.

The center output control operation (S300) may include: an obstacle detection operation (S310) of receiving at least one of data from a linked unit as data related to the front of the vehicle, the data including vehicle front image data, generated by matching images input from a plurality of camera sensors mounted on the vehicle into one view, and sensing data detected by the front ultra-sonic sensor, and detecting the obstacle positioned in front of the vehicle within the predetermined distance to analyze the distance information between the vehicle and the detected obstacle; a first determination operation (S320) of determining whether the distance information analyzed in the obstacle detection operation (S310) falls within a first predetermined distance; and a first control operation (S330) of controlling the waveform output from the corresponding ultra-sonic sensor to have the predetermined value when the distance information does not fall within the first predetermined distance, based on a result of the determination in the first determination operation (S320).

The center output control operation (S300) may further include: a second determination operation (S340) of determining whether the distance information analyzed in the obstacle detection operation (S310) falls in a range of a second predetermined distance when the distance information falls within the first predetermined distance, based on the result of the determination in the first determination operation (S320); and a second control operation (S350) of controlling the waveform output from the corresponding ultra-sonic sensor to correspond to the distance information when the distance information falls in the range of the second predetermined distance, based on a result of the determination in the second determination operation (S340).

The obstacle detection operation (S310) may include: a region segmentation operation (S311) of segmenting a region corresponding to an obstacle region from the vehicle front image data; and a first distance analysis operation (S312) of analyzing a pixel position corresponding to the obstacle region segmented in the region segmentation operation (S311) to analyze the distance information between the vehicle and the obstacle.

The obstacle detection operation (S310) may include a second distance analysis operation (S313) of analyzing the sensing data to analyze the distance information between the vehicle and the obstacle.

### BRIEF DESCRIPTION OF THE DRAWINGS

FIGS. 1 and 2 are exemplary views each showing interference with other vehicles occurring by driving of a conventional front ultra-sonic sensor;

FIG. 3 is a configuration diagram of a system for drive control of front ultra-sonic sensors according to an embodiment of the present disclosure;

FIG. 4 is a view showing a result of region segmentation of the system and method for drive control of front ultra-sonic sensors according to embodiments of the present disclosure;

FIGS. 5 and 6 are views each showing a drive control state of the ultra-sonic sensor by the system and method for drive control of front ultra-sonic sensors according to embodiments of the present disclosure; and

FIG. 7 is a flowchart of a method for drive control of front ultra-sonic sensors according to another embodiment of the present disclosure.

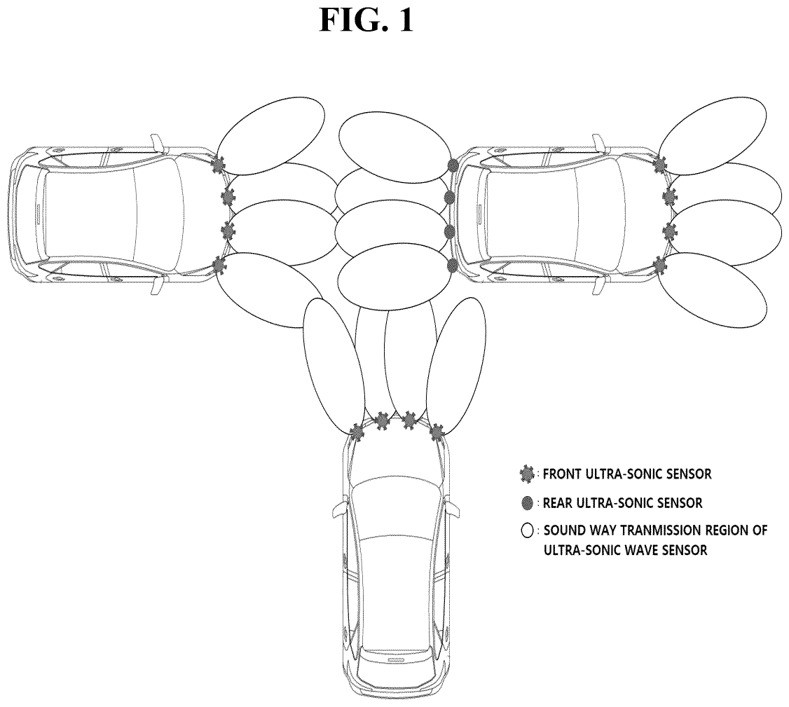

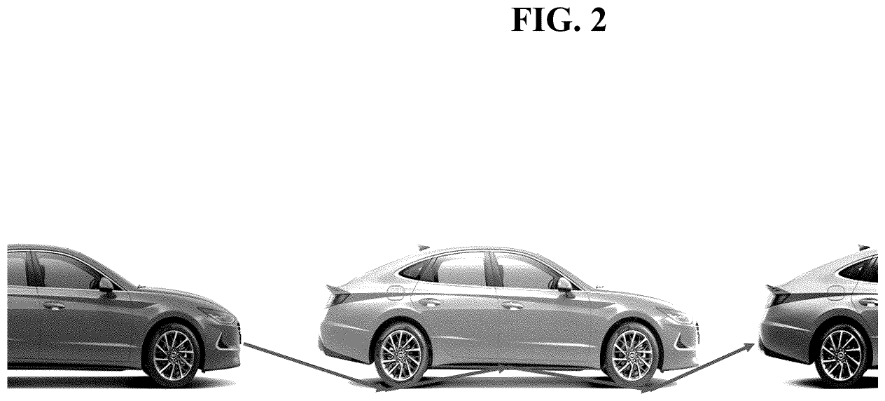

### DETAILED DESCRIPTION

Hereinafter, a system and a method for drive control of front ultra-sonic sensors according to embodiments of the present disclosure are described in detail with reference to the accompanying drawings.

A system may refer to a set of components including devices, mechanisms, means, and the like that are systematized and regularly interact with each other to perform required functions.

A front ultra-sonic sensor for a vehicle may detect the presence or absence of an obstacle in the front, and assist a driver's safe and comfortable driving in a complex driving environment, such as entering or exiting a parking lot or narrow alleyway having a narrow passage which requires a front parking distance warning (PDW) function.

However, as described above, when constantly driven, the front ultra-sonic sensor may act as a noise source for another vehicle and generate a false warning or the like, thereby lowering parking assist performance. In order to solve this problem, the front ultra-sonic sensor may be normally activated when the driver operates a PWD switch. However, this configuration may lead to a more significant problem that a risk of an accident is increased as the driver's concentration on driving is reduced due to the operation of the PWD switch.

Accordingly, the system and method for drive control of front ultra-sonic sensors according to an embodiment of the present disclosure may relate to technology for controlling a transmission waveform output from the front ultra-sonic sensor in consideration of its mounting position and a distance between an obstacle and the vehicle to constantly drive the front ultra-sonic sensor.

In brief, a front-lateral ultra-sonic sensor mounted on a side of the vehicle may have a smaller detection distance than a front center ultra-sonic sensor mounted on the center. However, front-lateral ultra-sonic sensor faces the front-lateral side of the vehicle, and a signal transmitted therefrom is thus highly likely to cause interference with another vehicle. The system and method for drive control of front ultra-sonic sensors according to an embodiment of the present disclosure proposes the technology for controlling a transmission waveform output from the front-lateral ultra-sonic sensor in consideration of this point.

In addition, when no obstacle exists in an adjacent space, the ultra-sonic wave output from the front center ultra-sonic sensor may also affect a wide region. Accordingly, the present disclosure proposes the technology for controlling a transmission waveform output from a front-center ultra-sonic sensor in response to the distance between the obstacle and the vehicle.

In this way, the ultra-sonic wave output from the front ultra-sonic sensor may be focused on a region of interest, which may minimize the sensor to act as the noise source for another vehicle, thereby minimizing its malfunctions (false warning/false alarm/misdetection, or the like) even when the front ultra-sonic sensor is constantly driven.

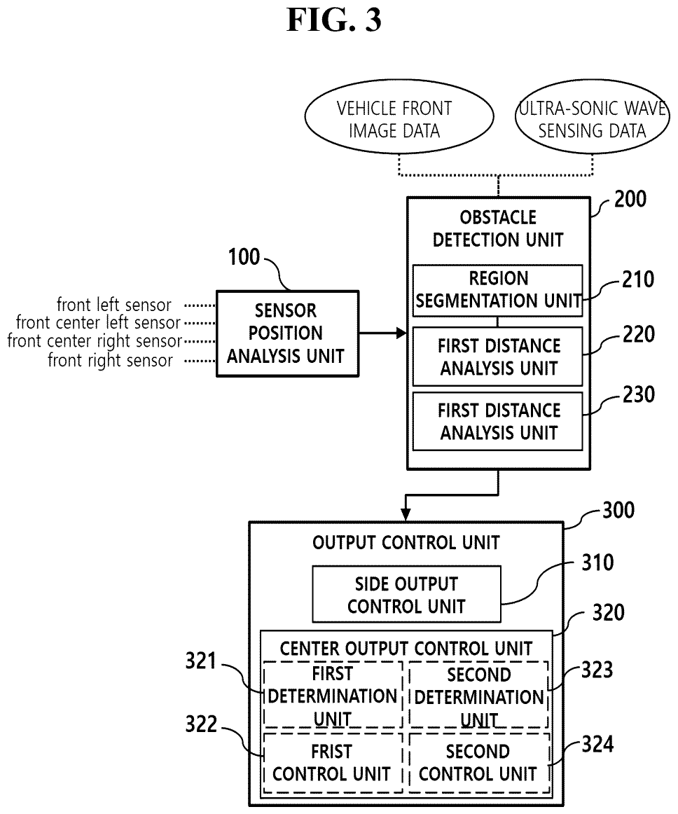

FIG. 3 is a configuration diagram of the system for drive control of front ultra-sonic sensors according to an embodiment of the present disclosure.

As shown in FIG. 3, the system for drive control of front ultra-sonic sensors according to an embodiment of the present disclosure may include a sensor position analysis unit 100, an obstacle detection unit 200, and an output control unit 300. Each component may perform its operation through a calculation processing means such as an electronic control unit (ECU) including a computer that performs transmission and reception through an in-vehicle communication channel.

In addition, in the system for drive control of front ultra-sonic sensors according to an embodiment of the present disclosure, at least four front ultra-sonic sensors (i.e., front left sensor, front center left sensor, front center right sensor, and front right center, as shown in FIG. 3) produced on the same production line as the same productions may be mounted on the front of the vehicle, and perform their operations in a state where the sensors are constantly driven to detect obstacles positioned in front of the vehicle.

For reference, at least four rear ultra-sonic sensors (i.e., rear left sensor, rear center left sensor, rear center right sensor, rear right sensor) produced on the same production line as the front ultra-sonic sensor may also be mounted on the rear of the vehicle, and perform their operations to detect obstacles positioned at the rear of the vehicle. The rear ultra-sonic sensor may be driven to be activated only when a vehicle gear is in the ‘R’ stage which is an explicit reverse situation.

The sensor position analysis unit 100 may analyze a mounting position of each of the plurality of front ultra-sonic sensors mounted on the vehicle, to classify a first ultra-sonic sensor mounted on the side (i.e., front-lateral ultra-sonic sensor such as the front left sensor or the front right sensor) and a second ultra-sonic sensor mounted on the center (i.e., front center ultra-sonic sensor such as the front center left sensor or the front center right sensor).

In detail, the sensor position analysis unit 100 may analyze the mounting position of each of the plurality of front ultra-sonic sensors by using identification (ID) information assigned in advance for each front ultra-sonic sensor or ID information assigned in advance to a connection cable of each front ultra-sonic sensor.

That is, the mounting positions may be classified based on a connection cable type of the plurality of rear ultra-sonic sensors. When one controller is connected to the same line (or uses a bus-type connection), the mounting position may be classified through personal identification number (PIN) ID additionally assigned to each rear ultra-sonic sensor. In addition, when one controller is connected to each line (or uses a star-type connection), the ID may be pre-assigned (or assigned in advance) to which position the sensor is mounted for each line, and the mounting position may be classified by using this assignment.

The obstacle detection unit 200 may detect an obstacle positioned in front of the vehicle within a predetermined distance by using input data related to the front of the vehicle to analyze distance information between the vehicle and the detected obstacle. The obstacle detection unit 200 may perform its operation in connection with the output control unit 300 when the sensor is the second ultra-sonic sensor based on an analysis result of the sensor position analysis unit 100, which is described in detail below.

The output control unit 300 may control the waveform output from each ultra-sonic sensor classified by the sensor position analysis unit 100 by using the distance information analyzed by the obstacle detection unit 200.

In detail, as shown in FIG. 3, the output control unit 300 may include a side output control unit 310 performing its operation when the sensor is the first ultra-sonic sensor mounted on the side (or front-lateral ultra-sonic sensor) as a result of the classification of the sensor position analysis unit 100, and a center output control unit 320 performing its operation when the sensor is the second ultra-sonic sensor mounted on the center (or front center ultra-sonic sensor) as a result of the classification of the sensor position analysis unit 100.

The side output control unit 310 may control the waveform output from the ultra-sonic sensor (e.g., first ultra-sonic sensor) to have a predetermined value when the sensor is the first ultra-sonic sensor mounted on the side (i.e., front-lateral ultra-sonic sensor) as a result of the classification of the sensor position analysis unit 100.

As described above, all the front ultra-sonic sensors mounted on the front of the vehicle may have the same specifications. However, when reviewing their requirements in detail, 120 cm may be the minimum detection distance condition of the front center ultra-sonic sensor, and may be the minimum detection distance condition of the front-lateral ultra-sonic sensor.

In consideration of the conditions, the side output control unit 310 may set the predetermined value as the minimum value set in consideration of the minimum detection distance condition of the front-lateral ultra-sonic sensor, and thus reduce the output transmission waveform to satisfy the minimum requirement of the sensor.

In this way, the side output control unit 310 may minimize the transmission waveform to act as the noise source for a front ultra-sonic sensor of another vehicle while satisfying the requirement of the front-lateral ultra-sonic sensor.

Here, the ultra-sonic sensor may generate a sound wave in such a manner that a pulse made using a current or voltage source is transmitted to an ultra-sonic wave converter while passing through a transformer and a matching circuit, and thus control the output transmission waveform by changing the magnitude of the current or voltage source.

In addition, the side output control unit 310 may adjust a reception amplification factor in an end of line (EOL) in advance based on a situation where the transmission waveform output from the front-lateral ultra-sonic sensor is reduced, and store its result so that the transmission waveform output from the front-lateral ultra-sonic sensor has the same sensitivity even when controlled to be reduced. The side output control unit 310 may then change and set the transmission waveform output from the front-lateral ultra-sonic sensor by using the stored reception amplification factor when controlling the waveform output from the sensor (or controlling the output transmission waveform of the sensor to be reduced) as described above. In this way, the side output control unit 310 may change and control the reception amplification factor so that the transmission waveform has the same sensitivity as before the reduction even when the transmission waveform is reduced.

The center output control unit 320 may control the waveform output from the corresponding ultra-sonic sensor (e.g., second ultra-sonic sensor) by using the distance information analyzed by the obstacle detection unit 200 when the sensor is the second ultra-sonic sensor mounted on the center (i.e., front center ultra-sonic sensor) as a result of the classification of the sensor position analysis unit 100.

Here, the obstacle detection unit 200 may receive at least one of data from a linked unit (e.g., surround view monitoring (SVM) system) as data related to the front of the vehicle, the data including vehicle front image data, generated by matching images input from a plurality of camera sensors mounted on the vehicle into one view, and sensing data detected by the front ultra-sonic sensor mounted on the vehicle.

The system for drive control of front ultra-sonic sensors according to an embodiment of the present disclosure may assist the safe and comfortable driving by constantly driving the front ultra-sonic sensor. However, this sensor is a component proving an additional function to solve problems caused thereby, and a more detailed control thereof may thus be inevitable.

Therefore, although both the vehicle front image data and the sensing data may be input, only one of the data may be input based on an internal/external environment of the vehicle.

For a proper explanation, the description first describes a case where all the data are input, and then also describes a case where only one of the data is input.

The ultra-sonic wave transmitted from the ultra-sonic sensor is more likely to interfere with another vehicle as a free space in front is wider. Accordingly, the center output control unit 320 may minimize unnecessary interference by reducing the transmission waveform output from the second ultra-sonic sensor when there is no obstacle within the predetermined distance.

As shown in FIG. 3, the obstacle detection unit 200 for analyzing the distance information between the vehicle and the obstacle may include a region segmentation unit 210 and a first distance analysis unit 220 for processing the vehicle front image data, and a second distance analysis unit 230 for processing the sensing data.

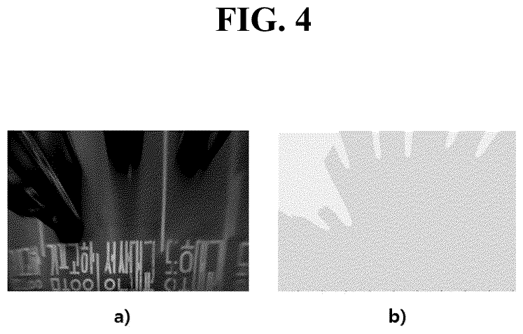

The region segmentation unit 210 may segment a region corresponding to an obstacle region from the vehicle front image data. In detail, the region segmentation unit 210 may receive the vehicle front image data (see FIG. 4A) converted into an air view by the SVM system, and apply a pre-stored semantic segmentation network to classify each pixel to a free space and the obstacle (e.g., vehicle) (see FIG. 4B).

That is, the region segmentation unit 210 may use the semantic segmentation network to determine what kind of object each of all the pixels included in the received vehicle front image data is, thereby classifying the pixels into a free space region and the obstacle region.

The pre-stored semantic segmentation network may use a semantic image segmentation algorithm of a fully convolutional network, which is only an example. The present disclosure is not limited thereto, and may use any network which may distinguish and classify desired regions through the image analysis/processing.

The first distance analysis unit 220 may analyze a pixel position corresponding to the obstacle region segmented by the region segmentation unit 210 to analyze the distance information between the vehicle and the obstacle. That is, each pixel position in the vehicle front image data converted to the air view may represent physical coordinates of each pixel, and the first distance analysis unit 220 may thus calculate the distance information by analyzing the pixel position corresponding to the obstacle region.

The second distance analysis unit 230 may analyze the sensing data through the front ultra-sonic sensor to analyze the distance information between the vehicle and the detected obstacle. The analysis of the distance information using the front ultra-sonic sensor is a unique function of the ultra-sonic sensor, and the description omits a detailed description thereof.

The center output control unit 320 may perform its operation by using the distance information between the vehicle and the obstacle, analyzed by the first distance analysis unit 220 or the second distance analysis unit 230, and in this way, may include a first determination unit 321, a first control unit 322, a second determination unit 323 and a second control unit 324 as shown in FIG. 3.

The first determination unit 321 may determine whether the distance information (or the distance information between the vehicle and the detected obstacle) falls within a first predetermined distance.

The first control unit 322 may control a waveform output from the second ultra-sonic sensor to have a predetermined value when the distance information does not fall within the first predetermined distance (or is more than the first predetermined distance), based on a result of the determination of the first determination unit 321. Here, the distance information does not fall within the first predetermined distance when an obstacle exists beyond the first predetermined distance or there is no obstacle.

The first control unit 322 may set the minimum value in consideration of the minimum detection distance condition of the front center ultra-sonic sensor as the predetermined value, and reduce the output transmission waveform to satisfy the minimum requirement of the sensor, and the second ultra-sonic sensor may thus determine only whether a nearby obstacle exists through the minimum output.

In this way, the first control unit 322 may minimize the transmission waveform to act as the noise source for the front ultra-sonic sensor of another vehicle while satisfying the requirement of the front center ultra-sonic sensor.

In the control of reducing the transmission waveform output from the second ultra-sonic sensor, the first control unit 322 may control the output waveform by changing a magnitude of a current source or a voltage source, similarly to the control of reducing the transmission waveform output from the first ultra-sonic sensor.

The first control unit 322 may adjust a reception amplification factor in an end of line (EOL) in advance based on a situation where the transmission waveform output from the front center ultra-sonic sensor is reduced to the minimum value, and store its result so that the transmission waveform output from the front center ultra-sonic sensor has the same sensitivity even when controlled to be reduced.

The first control unit 322 may then change and set the transmission waveform output from the front center ultra-sonic sensor by using the stored reception amplification factor when controlling the output transmission waveform of the sensor (or controlling the transmission waveform output from the sensor to be reduced to the minimum value). In this way, the first control unit 322 may change and control the reception amplification factor so that the transmission waveform has the same sensitivity as before the reduction even when the transmission waveform is reduced.

As such, it is enough for the sensor only to detect the nearby obstacle having a risk of collision within the first predetermined distance. However, the present disclosure sets 2 m as a reference distance for reducing the waveform output from the second ultra-sonic sensor to prevent the ultra-sonic wave signal from causing the interference rather than being blocked due to an excessively wide free space in front of the vehicle, which is only an example. The first predetermined distance may be a distance that a driver watching the front may sufficiently prepare for the presence of the obstacle beyond the first predetermined distance without a separate collision detection assist function. The first predetermined distance may be further increased based on a feedback or the like of the actual vehicle driver when the first predetermined distance is insufficient for the driver to detect and prepare for the obstacle without the collision detection assist function.

The second determination unit 323 may determine once again whether the distance information falls in a range of a second predetermined distance when the distance information falls within the first predetermined distance (or the first predetermined distance or less), that is, when the distance information between the vehicle and the detected obstacle is within 2 m, based on a result of the determination of the first determination unit 321.

The second control unit 324 may control the waveform output from the second ultra-sonic sensor to correspond to the distance information when the distance information falls in the range of the second predetermined distance, based on a result of the determination of the second determination unit 323.

In detail, the second determination unit 323 may set the range of the second predetermined distance to 0.6 m to 1.2 m, which is a distance at which ground reflection may occur, which is also only an example. To explain using this configuration for a proper explanation, the waveform output from the second ultra-sonic sensor may be controlled to remain in a default drive state when the distance information does not fall within the range of the second predetermined distance, based on the result of the determination of the second determination unit 323.

That is, the second control unit 324 may control the second ultra-sonic sensor to have an output waveform corresponding to the distance information calculated by Equation 1 below when the distance information is 0.6 m or more and 1.2 m or less.

[Equation 1]

y=150/0.6(x−0.6)+100

(Here, y is a transmitted current, and x is the distance information).

The second control unit 324 may adjust each reception amplification factor in an end of line (EOL) in advance based on each situation where the transmission waveform output from the front center ultra-sonic sensor is gradually reduced, and store its result so that the transmission waveform output from the front center ultra-sonic sensor has the same sensitivity even when controlled to be reduced in response to the distance information.

The second control unit 324 may then gradually change and set the transmission waveform output from the front center ultra-sonic sensor by using the stored reception amplification factor when controlling the output transmission waveform (or controlling the output waveform to be gradually reduced). In this way, the second control unit 324 may change and control the reception amplification factor so that the transmission waveform has the same sensitivity as before the reduction even when the transmission waveform is reduced.

In addition, the second control unit 324 may control the second ultra-sonic sensor to produce a normal output in the default drive state, thereby performing remote detection when the distance information is more than 1.2 m and 2 m or less, and may control the second ultra-sonic sensor to produce the normal output in the default drive state, thereby detecting an obstacle which may impact a vehicle bumper, such as a road bump, in case that the vehicle out of a beam angle has the minimum ground clearance when the distance information is less than 0.6 m.

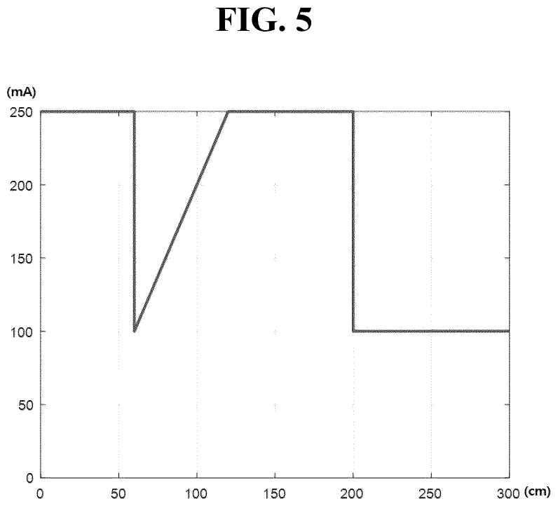

As shown in FIG. 5, the second control unit 324 may control the waveform output from the front center ultra-sonic sensor to be reduced to the minimum possible value when there is no nearby obstacle within 2 m of the vehicle; may control the waveform output from the front center ultra-sonic sensor to perform the remote detection through the normal output in the default drive state when the nearby obstacle is detected (or when the obstacle is detected in the distance of more than 1.2 m and 2 m or less); may control the waveform output from the front center ultra-sonic sensor to be reduced in response to the distance information to minimize the interference with another vehicle, occurring due to a ground reflection wave when a more nearby obstacle is detected (or in the distance of 0.6 m or more to 1.2 m or less); and may control the waveform output from the front center ultra-sonic sensor to return to the default drive state to detect a road condition outside the beam angle when an ultra-nearby obstacle is detected (or in the distance of less than 0.6 m).

In this way, the output control unit 300 may variably control the waveform output from the front ultra-sonic sensor based on the mounting position of the sensor and the distance between the vehicle and the obstacle, thereby minimizing the ultra-sonic wave transmitted to another vehicle even when the front ultra-sonic sensor is constantly driven, which may solve the problems described above.

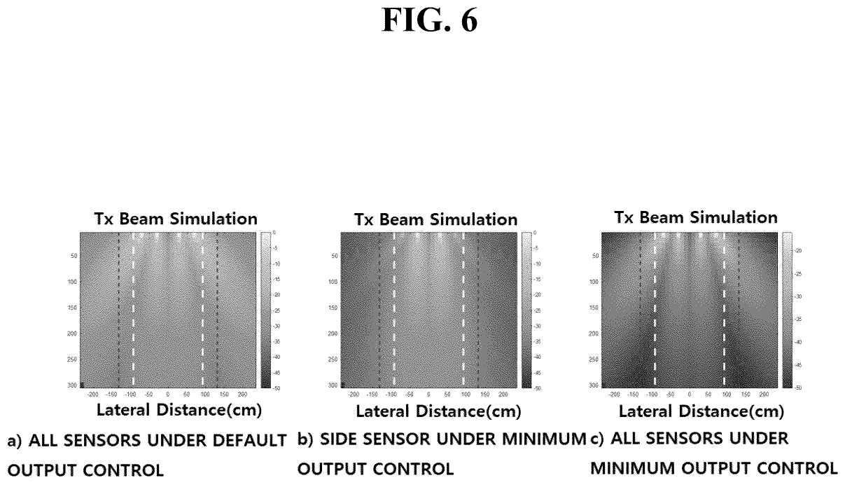

FIG. 6 is a view showing each beam pattern of the waveforms output from the first ultra-sonic sensor and the second ultra-sonic sensor, controlled by the output control unit 300.

In detail, FIG. 6A shows each beam pattern in which the waveforms of the first ultra-sonic sensors and the second ultra-sonic sensors are output in the default drive state without being controlled by the output control unit 300; and FIG. 6B is a beam pattern of a case where a nearby obstacle exists in front of the vehicle, and in which the waveform output from the first ultra-sonic sensor is controlled to be reduced to the minimum possible value, and energy is concentrated in the front. In addition, FIG. 6C is a beam pattern of the free space without any nearby obstacle, in which both the output waveforms of the first ultra-sonic sensor and the second ultra-sonic sensor are controlled to be reduced to the minimum possible values, and only the nearby obstacle is detected.

In general, 1.2 m may be the minimum detection range requirement of the front ultra-sonic sensor, and the vehicle front image data may thus be required to analyze a region beyond this requirement, which has the distance information of more than 1.2 m.

In consideration of this point, the obstacle detection unit 200 may analyze the distance information through the above-described process when both the vehicle front image data and the sensing data are input, and the output control unit 300 may perform its operation based thereon.

However, the region segmentation unit 210 and the first distance analysis unit 220 may sufficiently determine all necessary regions (that is, whether an obstacle exists within the first predetermined distance or whether an obstacle exists within the range of the second predetermined distance) when only the vehicle front image data is input, and the output control unit 300 may perform its operation based thereon.

However, the output control unit 300 may assume that the front ultra-sonic sensor in the worst condition satisfies only the minimum detection range requirement when only the sensing data is input, and determine that an obstacle exists in the distance of more than 1.2 m when failing to detect the obstacle through the sensing data, thus controlling the waveform output from the front center ultra-sonic sensor to be in the default drive state to maintain the normal output. The second distance analysis unit 230 may analyze the distance information between the vehicle and the obstacle in the distance of 1.2 m or less when the obstacle is detected through sensing data during the above maintenance process, and the output control unit 300 may perform its operation based thereon. In case that the second determination unit 323 and the second control unit 324 are operated, the output control unit 300 may control the waveform to be reduced based on the distance information which is 0.6 m or more and 1.2 m or less, and may control the waveform to be in the default drive state based on the distance information which is less than 0.6 m.

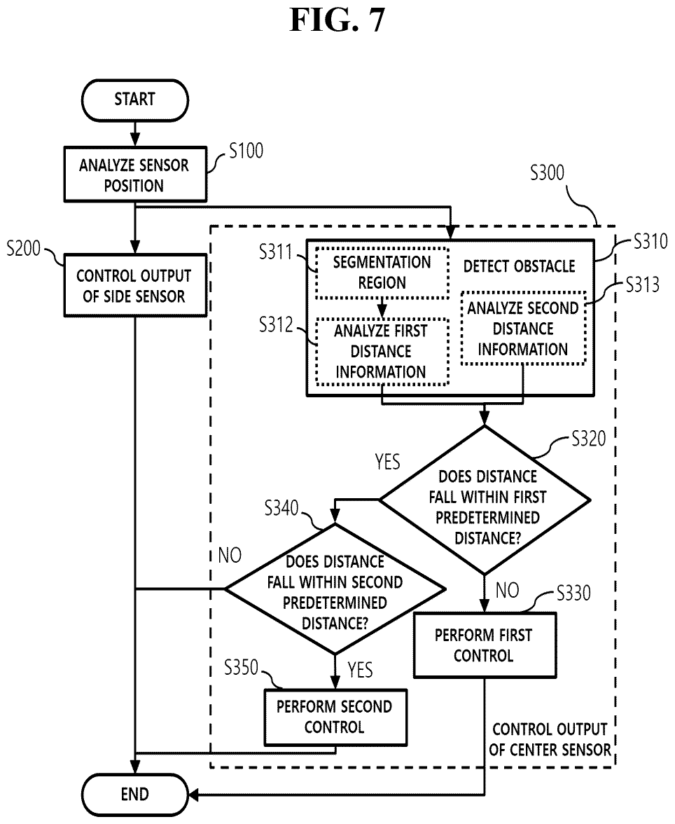

FIG. 7 is a flowchart of a method for drive control of front ultra-sonic sensors according to another embodiment of the present disclosure.

As shown in FIG. 7, the method for drive control of front ultra-sonic sensors according to another embodiment of the present disclosure may include a sensor position analysis operation (S100), a side output control operation (S200), and a center output control operation (S300). Each operation may be performed using the system for drive control of front ultra-sonic sensors that are operated by a calculation processing means.

A first operation of the method for drive control of front ultra-sonic sensors according to another embodiment of the present disclosure may be performed when at least four front ultra-sonic sensors mounted on the front of a vehicle and detecting obstacles positioned in front of the vehicle are constantly driven.

The sensor position analysis operation (S100) may be an operation of classifying a first ultra-sonic sensor mounted on the side (i.e., front-lateral ultra-sonic sensor such as the front left sensor or the front right sensor) and a second ultra-sonic sensor mounted on the center (i.e., front center ultra-sonic sensor such as the front center left sensor or the front center right sensor) by analyzing a mounting position of each of the plurality of front ultra-sonic sensors mounted on the front of the vehicle.

In the sensor position analysis operation (S100), the mounting position of each of the plurality of front ultra-sonic sensors may be analyzed by using identification (ID) information assigned in advance for each front ultra-sonic sensor or ID information assigned in advance to a connection cable of each front ultra-sonic sensor.

That is, the mounting positions may be classified based on a connection cable type of the plurality of rear ultra-sonic sensors. When one controller is connected to the same line (or uses a bus-type connection), the mounting position may be classified through personal identification number (PIN) ID additionally assigned to each rear ultra-sonic sensor. On the other hand, when one controller is connected to each line (or uses a star-type connection), the ID may be assigned in advance to which position the sensor is mounted for each line, and the mounting position may be classified by using this assignment.

The side output control operation (S200) may be an operation of controlling, by an output control unit 300 as the calculation processing means, a waveform output from the ultra-sonic sensor (e.g., first ultra-sonic sensor) to have a predetermined value when the sensor is the first ultra-sonic sensor as a result of the classification in the sensor position analysis operation (S100).

Here, the minimum value set in consideration of the minimum detection distance condition of the front-lateral ultra-sonic sensor may be set as the predetermined value, and the output transmission waveform may thus be reduced to satisfy the minimum requirement of the sensor.

In this way, it is possible to minimize the transmission waveform to act as the noise source for a front ultra-sonic sensor of another vehicle while the requirement of the front-lateral ultra-sonic sensor is satisfied.

Here, the ultra-sonic sensor may generate a sound wave in such a manner that a pulse made using a current or voltage source is transmitted to an ultra-sonic wave converter while passing through a transformer and a matching circuit, and thus control the output transmission waveform by changing the size of the current or voltage source.

In addition, a reception amplification factor may be adjusted in an end of line (EOL) in advance based on a situation where the transmission waveform output from the front-lateral ultra-sonic sensor is reduced, and its result may be stored so that the transmission waveform output from the front-lateral ultra-sonic sensor has the same sensitivity even when controlled to be reduced. The output transmission waveform may then be changed and set by the stored reception amplification factor when the waveform output from the front-lateral ultra-sonic sensor is controlled (or the output transmission waveform is controlled to be reduced). In this way, the reception amplification factor may be changed and controlled so that the transmission waveform has the same sensitivity as before the reduction even when the transmission waveform is reduced.

The center output control operation (S300) may be an operation of controlling, by the calculation processing means, a waveform output from the second ultra-sonic sensor by analyzing distance information between the vehicle and an obstacle positioned in front of the vehicle within a predetermined distance when the sensor is the second ultra-sonic sensor mounted on the center (or front center ultra-sonic sensor) as the result of the classification in the sensor position analysis operation (S100).

To this end, as shown in FIG. 7, the center output control operation (S300) may include an obstacle detection operation (S310), a first determination operation (S320) and a first control operation (S330).

The obstacle detection operation (S310) may be an operation of receiving at least one of data from a linked unit (e.g., surround view monitoring (SVM) system) by an obstacle detection unit 200 as the calculation processing means, the data including vehicle front image data, generated by matching images input from a plurality of camera sensors mounted on the vehicle into one view, and sensing data detected by the front ultra-sonic sensor mounted on the vehicle.

In the obstacle detection operation (S310), the obstacle positioned in front of the vehicle within the predetermined distance may be detected using the input data, and the distance information may thus be analyzed.

In detail, as shown in FIG. 7, the obstacle detection operation (S310) may include a region segmentation operation (S311) and a first distance analysis operation (S312), performed when the input data is the vehicle front image data, and a second distance analysis operation (S313) performed when the input data is the sensing data.

The region segmentation operation (S311) may be an operation of segmenting a region corresponding to an obstacle region from the vehicle front image data. That is, in the region segmentation operation (S311), the vehicle front image data (see FIG. 4A) converted into an air view by the SVM system may be input, and a pre-stored semantic segmentation network may be applied to classify each pixel to a free space and the obstacle (e.g., vehicle) (see FIG. 4B). In detail, in the region segmentation operation (S311), the semantic segmentation network may be used to determine what kind of object each of all the pixels included in the received vehicle front image data is, thereby classifying the pixels into a free space region and the obstacle region. The pre-stored semantic segmentation network may be a semantic image segmentation algorithm including fully convolutional networks, which is only an example of the present disclosure. The present disclosure is not limited thereto, and may use any network that may distinguish and classify desired regions through the image analysis/processing.

The first distance analysis operation (S312) may be an operation of analyzing a pixel position corresponding to the obstacle region segmented in the region segmentation operation (S311) to analyze the distance information between the vehicle and the obstacle. That is, each pixel position in the vehicle front image data converted to the air view may represent physical coordinates of each pixel, and the distance information may thus be calculated by analyzing the pixel position corresponding to the obstacle region.

The second distance analysis operation (S313) may be an operation of analyzing the sensing data through the front ultra-sonic sensor to analyze the distance information between the vehicle and the detected obstacle. The analysis of the distance information using the front ultra-sonic sensor is a unique function of the ultra-sonic sensor, and the description omits a detailed description thereof.

The first determination operation (S320) may be an operation of determining, by an output control unit 300 as the calculation processing means, whether the distance information between the vehicle and the obstacle, analyzed in the first distance analysis operation (S312) or the second distance analysis operation (S313), falls within a first predetermined distance.

The first control operation (S330) may be an operation of controlling, by the output control unit 300 as the calculation processing means, the waveform output from the second ultra-sonic sensor to have a predetermined value when the distance information does not fall within the first predetermined distance (or is more than the first predetermined distance), based on a result of the determination in the first determination operation (S320). Here, the distance information does not fall within the first predetermined distance when an obstacle exists beyond the first predetermined distance or there is no obstacle.

In detail, in the first control operation (S330), the predetermined value may be set as the minimum value in consideration of the minimum detection distance condition of the front center ultra-sonic sensor, and the output transmission waveform may thus be reduced to satisfy the minimum requirement; and only whether there is a nearby obstacle may be determined by the second ultra-sonic sensor through the minimum output.

In this way, in the first control operation (S330), it is possible to minimize the transmission waveform to act as the noise source for the front ultra-sonic sensor of another vehicle while the requirement of the front center ultra-sonic sensor is satisfied.

In the control of reducing the transmission waveform output from the second ultra-sonic sensor, the output waveform may be controlled by changing a magnitude of a current source or a voltage source, similarly to the control of reducing the transmission waveform output from the first ultra-sonic sensor.

In the first control operation (S330), a reception amplification factor may be adjusted in an end of line (EOL) in advance based on a situation where the transmission waveform output from the front center ultra-sonic sensor is reduced to the minimum value, and store its result so that the transmission waveform output from the front center ultra-sonic sensor has the same sensitivity even when controlled to be reduced.

The transmission waveform output from the front center ultra-sonic sensor may be changed and set by using the stored reception amplification factor when the output waveform is controlled (or the output waveform is controlled to be reduced to the minimum value). In this way, the reception amplification factor may be changed and controlled so that the transmission waveform has the same sensitivity as before the reduction even when the transmission waveform is reduced.

As such, it may only be required to detect the nearby obstacle having a risk of collision in a first predetermined distance. However, the present disclosure sets 2 m as a reference distance for reducing the waveform output from the second ultra-sonic sensor to prevent the ultra-sonic wave signal from causing the interference rather than being blocked due to an excessively wide free space in front of the vehicle, which is only an example. The first predetermined distance may be a distance that a driver watching the front may sufficiently prepare for the presence of the obstacle beyond the first predetermined distance without a separate collision detection assist function. The first predetermined distance may be further increased based on a feedback or the like of the actual vehicle driver when the first predetermined distance is insufficient for the driver to detect and prepare for the obstacle without the collision detection assist function.

As shown in FIG. 7, the center output control operation (S300) may further include a second determination operation (S340) and a second control operation (S350) when the distance information falls within the first predetermined distance (or the first predetermined distance or less), based on the result of the determination in the first determination operation (S320).

The second determination operation (S340) may be an operation of determining once again, by the output control unit 300 as the calculation processing means, whether the distance information falls in a range of a second predetermined distance when the distance information falls within the first predetermined distance (or the first predetermined distance or less), that is, when the distance information between the vehicle and the detected obstacle is within 2 m.

The second control operation (S350) may be an operation of controlling, by the output control unit 300 as the calculation processing means, the waveform output from the second ultra-sonic sensor to correspond to the distance information when the distance information falls in the range of the second predetermined distance, based on a result of the determination in the second determination operation (S340).

Here, the range of the second predetermined distance is set to 0.6 m to 1.2 m, which is the distance at which ground reflection may occur, which is also only an example.

To explain using this configuration for a proper explanation, in the second control operation (S350), the second ultra-sonic sensor may be controlled to have an output waveform corresponding to the distance information calculated by Equation 1 above when the distance information falls in the range of the second predetermined distance (or when the distance information is 0.6 m or more and 1.2 m or less), based on the result of the determination in the determination operation (S340).

In the second control operation (S350), each reception amplification factor may be adjusted in an end of line (EOL) in advance based on each situation where the transmission waveform output from the front center ultra-sonic sensor is gradually reduced, and its result may be stored so that the transmission waveform output from the front center ultra-sonic sensor has the same sensitivity even when controlled to be reduced in response to the distance information.

The transmission waveform output from the front center ultra-sonic sensor may then be gradually changed and set by using the stored reception amplification factor when the output waveform is controlled (or the output transmission waveform is controlled to be gradually reduced). In this way, the reception amplification factor may be changed and controlled so that the transmission waveform has the same sensitivity as before the reduction even when the transmission waveform is reduced.

In addition, the waveform output from the second ultra-sonic sensor may be controlled to remain in a default drive state when the distance information does not fall within the range of the second predetermined distance (or more than 1.2 and is 2 m or less or less than 0.6 m), based on the result of the determination in the second determination operation (S340).

In detail, the second ultra-sonic sensor may be controlled to produce a normal output in the default drive state, and remote detection may thus be performed when the distance information is more than 1.2 m and 2 m or less, and the second ultra-sonic sensor may be controlled to produce the normal output in the default drive state, an obstacle which may impact a vehicle bumper, such as a road bump, may thus be detected when the vehicle out of an beam angle has the minimum ground clearance in case that the distance information is less than 0.6 m.

In this way, the waveform output from the front ultra-sonic sensor may be variably controlled based on the mounting position of the sensor and the distance between the vehicle and the obstacle, and the ultra-sonic wave transmitted to another vehicle may thus be minimized even when the front ultra-sonic sensor is constantly driven, which may solve the problems described above.

According to the system and method for drive control of front ultra-sonic sensors according to the present disclosure as described above, it is possible to constantly drive the front ultra-sonic sensor mounted on the front of the vehicle, thereby providing the front parking distance warning (PDW) function to assist the driver's safe and comfortable driving when entering or exiting the parking lot or narrow alley having a narrow passage without the driver's separate operation that reduces his/her driving concentration.

In particular, in order to constantly drive the front ultra-sonic sensor, the transmission energy may be concentrated in the region of interest while being blocked from being transmitted to another vehicle by variably controlling the transmission waveform of the front ultra-sonic sensor in consideration of the mounting position of the front ultra-sonic sensor and the distance between the vehicle and the obstacle. It is thus possible to solve the problems of the lower parking assist performance, such as a false warning occurring by the front ultra-sonic sensor acting as the noise source for another vehicle which is an inevitable problem occurring when the sensor is constantly driven, etc.

In this way, the ultra-sonic sensor may be driven constantly even in a complex alleyway or on a narrow road, thereby improving the driving convenience while reducing the probability of an accident.

The present disclosure is not limited to the above-mentioned embodiments, may be variously applied, and may be variously modified without departing from the gist of the present disclosure claimed in the claims.

What is claimed is:

1. A system for control of front ultra-sonic sensors mounted on the front of a vehicle and detecting an obstacle in front of the vehicle, the system comprising:
a sensor position analysis unit for analyzing a mounting position of each of a plurality of front ultra-sonic sensors mounted on the vehicle to classify (1) a first ultra-sonic sensor mounted to the side and (2) a second ultra-sonic sensor mounted to the center of the front of the vehicle;
an obstacle detection unit for detecting the obstacle positioned within a predetermined distance in front of the vehicle by using input data related to the front of the vehicle in order to analyze distance information between the vehicle and the detected obstacle; and
an output control unit for controlling a waveform produced by each ultra-sonic sensor classified by the sensor position analysis unit by using distance information analyzed by the obstacle detection unit.

2. The system of claim 1, wherein the sensor position analysis unit analyzes the mounting position to a connection cable of each front ultra-sonic sensor of each of the plurality of front ultra-sonic sensors by using pre-assigned identification (ID) information for each front ultra-sonic sensor or pre-assigned ID information.

3. The system of claim 1, wherein the obstacle detection unit receives linked data including at least one of (1) data related to the front of the vehicle combined from a plurality of camera sensors mounted on the vehicle into one view, and (2) sensing data detected by the front ultra-sonic sensor.

4. The system of claim 3, wherein the obstacle detection unit includes:
a region segmentation unit for segmenting a region corresponding to an obstacle region from the vehicle front image data; and
a first distance analysis unit for analyzing a pixel position corresponding to the obstacle region segmented by the region segmentation unit to determine the distance information between the vehicle and the detected obstacle.

5. The system of claim 3, wherein the obstacle detection unit further includes a second distance analysis unit for analyzing the sensing data to determine the distance information between the vehicle and the detected obstacle.

6. The system of claim 1, wherein the output control unit includes a side output control unit for controlling the waveform output from the ultra-sonic sensor to have a predetermined value when the sensor is determined by the sensor position analysis unit to be the first ultra-sonic sensor.

7. The system of claim 1, wherein the output control unit includes a center output control unit for controlling the waveform output from the corresponding ultra-sonic sensor by using the distance information analyzed by the obstacle detection unit when the sensor is determined by the sensor position analysis unit to be the second ultra-sonic sensor.

8. The system of claim 7, wherein the center output control unit includes:
a first determination unit for determining whether the distance information falls within a first predetermined distance; and
a first control unit for controlling a waveform output from the corresponding ultra-sonic sensor to have a predetermined value when the distance information, based on a result of the determination of the first determination unit, does not fall within the first predetermined distance.

9. The system of claim 8, wherein the center output control unit includes:
a second determination unit for determining whether the distance information falls in a range of a second predetermined distance when the distance information, based on the result of the determination of the first determination unit, falls within the first predetermined distance; and
a second control unit for controlling the waveform output from the corresponding ultra-sonic sensor to correspond to the distance information when the distance information, based on a result of the determination of the second determination unit, falls in the range of the second predetermined distance.

10. A processor-implemented method for drive control of front ultra-sonic sensors, the method comprising steps of:
analyzing a mounting position of each of a plurality of front ultra-sonic sensors mounted on the front of a vehicle to classify a first ultra-sonic sensor mounted on the side of the front of the vehicle and a second ultra-sonic sensor mounted on the center of the front of the vehicle;
controlling a side-output waveform output from a corresponding ultra-sonic sensor to have a predetermined value when the sensor is classified as the first ultra-sonic sensor; and
controlling a center-output waveform from a corresponding ultra-sonic sensor by analyzing distance information between the vehicle and an obstacle positioned in front of the vehicle to be within a predetermined distance determined by sensor position analysis when the sensor is the second ultra-sonic sensor.

11. The method of claim 10, wherein analyzing the mounting position of each of the plurality of front ultra-sonic sensors in the analyzing step by using identification (ID) information pre-assigned for each front ultra-sonic sensor or ID information pre-assigned to a connection cable of each front ultra-sonic sensor.

12. The method of claim 10, wherein the center-output waveform controlling includes:
receiving data related to the front of the vehicle, the data including vehicle front image data, generated by matching, into one view, images input from a plurality of camera sensors mounted on the vehicle, sensing data detected by the front ultra-sonic sensor, and detecting an obstacle positioned in front of the vehicle within the predetermined distance, to analyze the distance information between the vehicle and the detected obstacle;
determining whether the distance information falls within a first predetermined distance; and
controlling the waveform output from a corresponding ultra-sonic sensor to have the predetermined value when the distance information does not fall within the first predetermined distance, based on a result of the determining.

13. The method of claim 12, wherein the center output waveform controlling further includes:
determining whether the analyzed distance information falls in a range of a second predetermined distance when the distance information falls within the first predetermined distance; and
controlling the waveform output from the corresponding ultra-sonic sensor to correspond to the distance information when the distance information falls in the range of the second predetermined distance.

14. The method of claim 12, wherein the obstacle detecting includes:
segmenting a region corresponding to an obstacle region from the vehicle front image data; and
analyzing a pixel position corresponding to the obstacle segmented region to analyze the distance information between the vehicle and the obstacle.

15. The method of claim 12, including analyzing the sensing data to determine the distance information between the vehicle and the obstacle.
